(19) United States
(12) Patent Application Publication
(10) Pub. No.: US 2001/0054621 A1
(43) Pub. Date: Dec. 27, 2001

(54) Container cap with anti-slip flange

(76) Inventor: Heinz Weber, Beaconsfield (CA)

Correspondence Address: Eric Fincham, 316 Knowlton Road, Lac Brome, QC, J0E 1V0, CA

(21) Appl. No.: 09/837,706

(22) Filed: Apr. 18, 2001

Related U.S. Application Data
(63) Continuation-in-part of application No. 09/374,356, filed on Aug. 13, 1999, now abandoned.
(60) Provisional application No. 60/131,010, filed on Apr. 26, 1999.

(51) Int. Cl. G01F 11/06; B67D 1/16; B65D 25/40

(52) U.S. Cl. 222/108; 222/323; 222/324; 222/321.9; 222/571

(57) ABSTRACT

A cap for use with a pump spray container, the cap having a body with an internal passageway to receive a spray mechanism, and having a side wall surrounding the passageway, a flange extending outwardly from an exterior surface of the side wall of the cap, the cap extending outwardly for a distance sufficient to act as an abutting member for a finger of a user's hand. The cap correctly positions the fingers of the user and prevents slippage of the container within the hand of the user.

This application is a Continuation-in-Part of application Ser. No. 09/374,356 filed Aug. 13, 1999.

### FIELD OF THE INVENTION

The present invention relates to the field of containers and more particularly, relates to a container cap.

### BACKGROUND OF THE INVENTION

The dispensing of fluids in a spray is well known in the art and many different products are so packaged. Such products include, for example, cosmetic fluids such as hair spray and medicinal sprays such as mouth sprays.

The type of spray used may generally be characterized as those formed by means of a pump arranged on the container closure and which is activated by pressure of the finger or thumb of the user or the so called spray can which generally utilizes a propellant gas. Generally, the use of the propellant gas is in disfavor for many different reasons including environmental considerations. Thus, certain propellant gases have been shown to be carcinogenic while others, such as medicinal sprays, do not readily lend themselves to use of a propellant gas.

The pump sprays have been known for a number of years and many different types are used in the art. Basically, they provide an atomization of the fluid and provide a superior product usage compared to the propellant gas sprays. However, such pumps are dependent upon the pressure delivered by the finger or thumb of the user. One problem which occurs with such pump sprays is the container may become contaminated on the exterior surface with the spray which can then cause slippage and accordingly, a lower pressure is applied on the pump and the atomization is therefore insufficient.

In order to overcome the above problems and to provide a proper grip on the container, it has been proposed in the art to provide containers which have various configurations to receive the hands of the user and to thus provide a more secure grip on the container and allow for the proper pumping action on the pump member. However, such an arrangement is only suitable for larger containers and it has been found that such an arrangement does not provide for the most ergonomic placement of the hands on the pump for actuation thereof.

### SUMMARY OF THE INVENTION

It is an object of the present invention to provide an ergonomic pump spray container.

It is a further object of the present invention to provide a cap for use with a pump spray container and which cap has anti-slip features.

It is a further object of the present invention to provide a cap for a pump spray container and which cap is ergonomically designed to automatically position the fingers of the user in a comfortable and effective position.

According to one aspect of the present invention, there is provided a cap for use with a pump spray container, the cap comprising a body having an internal passageway to receive a spray mechanism, a side wall surrounding the passageway, a flange extending outwardly from an exterior surface of the side wall, the flange extending outwardly for a distance sufficient to act as an abutting member for a finger of a hand of a user.

According to a further aspect of the present invention, there is provided a method of positioning the index finger of a user on a spray container having a plunger, the method comprising the step of supplying a container having a cap, the cap comprising a body including a side wall, a flange extending outwardly from an exterior surface of the side wall, the flange extending outwardly for a distance sufficient to act as an abutting member for a finger of a hand of a user and the flange being spaced from the plunger by a distance sufficient to correctly position the index finger.

The cap of the present invention may be utilized with any suitable spray head. Thus, it may be utilized with propellant based spray heads as well as the pump action type of spray head although the maximum benefit will be gained from the pump action as the propellant based spray may not require the same force exerted on the head.

In a preferred embodiment, the flange is formed as an integral part of the cap although it is within the scope of the invention to have a separate member secured thereto. Similarly, it is preferred that the flange form a portion of the cap member per se since this would normally provide the correct spacing for use of the spray head, a separate member connected to another portion of the cover/container could accomplish the same purpose of correctly positioning the fingers on the cover/container. Preferably, the flange will extend outwardly a distance of between 5 mm and 20 mm and the flange will be spaced from the top of the plunger by a distance of between 2 cm and 6 cm. Even more preferably, the flange will extend outwardly at least 10 mm and will be spaced from the top of the plunger by a distance of between 2 cm and 4 cm. By so doing, it has been found that the user will use all three muscles in the finger rather than only one or two muscles as would be the case with prior art caps.

The cap may be formed of any suitable material and conventionally and preferably, it is formed of a molded plastics material and which cap would be screw threadably engageable with the mouth of the container.

In a prefered embodiment of the invention, the flange incorporates means for preventing any drops or droplets from contacting the fingers of the user. To this end, the flange may include an upwardly extending lip or equivalent structure for the purposes of retaining any drops or droplets from the atomized spray from falling below the level of the flange.

Alternatively, an absorbent material may be placed below the spray head and above the flange to absorb any liquid.

In a still further embodiment, one may combine the absorbent material and the lip structure to prevent liquid from contacting the fingers of the user.

Any suitable absorbent material may be utilized with a particularly preferred one being a foam type which has a capacity to absorb a substantial amount of liquid. The absorbent material may be adhesively adhered to the lip or outer wall of the cap or alternatively, it may be sized to resiliently fit in the desired position.

### BRIEF DESCRIPTION OF THE DRAWINGS

Having thus generally described the invention, reference will be made to the accompanying drawings illustrating an embodiment thereof, in which:

FIG. 1 is a perspective view of a container and container cap according to the present invention;

FIG. 2 is a view of a prior art container illustrating use of the container;

FIG. 3 is a side view illustrating use of the container of the present invention; and

FIG. 4 is a detail view, partially in section, illustrating the absorbent material.

### DESCRIPTION OF THE PREFERRED EMBODIMENTS

Referring to the drawings in greater detail and by reference characters thereto, there is illustrated in FIG. 2 a pump spray container known in the prior art and which pump spray container is generally designated by reference numeral 10.

Pump spray container 10 includes a generally cylindrical body portion 12 having a cap 14 mounted thereon. A plunger 16 passes through an aperture in cap 14 and in a known manner, the contents of the container are pressurized and discharged through a dispensing aperture 18 located in the upper portion of plunger 16. Plunger 16 includes a finger rest 20 as its upper surface. As aforementioned, this arrangement is known and conventional in the art.

In operation, a user will use an index finger 22 shown in dotted lines with the thumb 24 being placed against the side of the container. On the opposite side, pressure is exerted by middle finger 26 to hold the container in a fixed position while the index finger 22 operates the plunger 16.

If the person's fingers are dry and they are able to exert sufficient pressure by means of thumb 24 and middle finger 26, the above system functions well. However, in the case of the elderly or when the container is slippery such as frequently occurs in hair salons and the like, thumb 24 and middle finger 26 tend to slip upwardly on the container and sufficient pressure can not be exerted by index finger 22 on plunger 16.

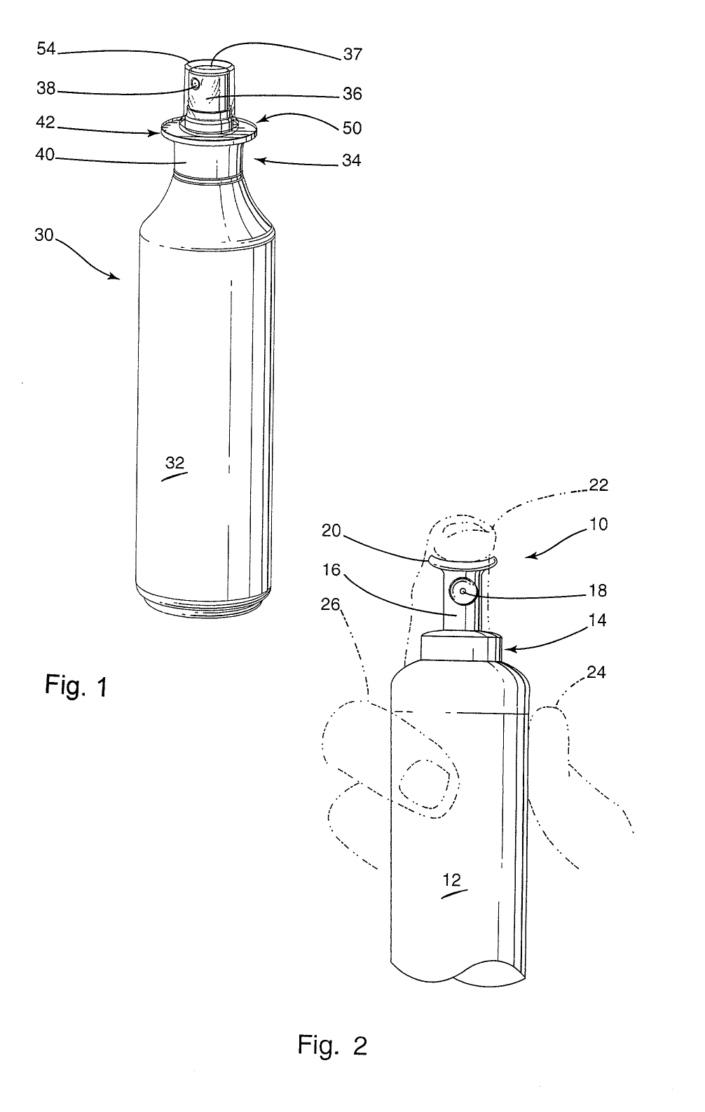

The cap of the present invention is illustrated in FIG. 1 and reference will now be made thereto.

Cap 34 of the present invention is placed on a container 30 substantially identical to container 10 shown in FIG. 2. Thus, container 30 has a cylindrical body 32 while passing through cap 34 there is provided a plunger 36 having finger rest 37 thereon and a dispensing aperture 38.

Cap 34 includes a generally annular side wall 40 while, at its upper end thereof, there is provided an outwardly extending flange generally designated by reference numeral 42. Flange 42 includes an annular flange side wall 44. Extending downwardly from annular flange side wall 44 is a bottom wall 46 which merges arcuately with side wall 40 of cap 34.

Located at the upper peripheral edge of flange side wall 44 is a lip 48 which encloses a recess 50 formed in the top surface of flange 42. Mounted in recess 50 is an absorbent material such as foam 52. As may be seen, foam 52 will absorb any liquid which may drip from dispensing aperture 38 of plunger 36.

A cover member 54 may be provided for protecting plunger 36 when not in use as is well known in the art.

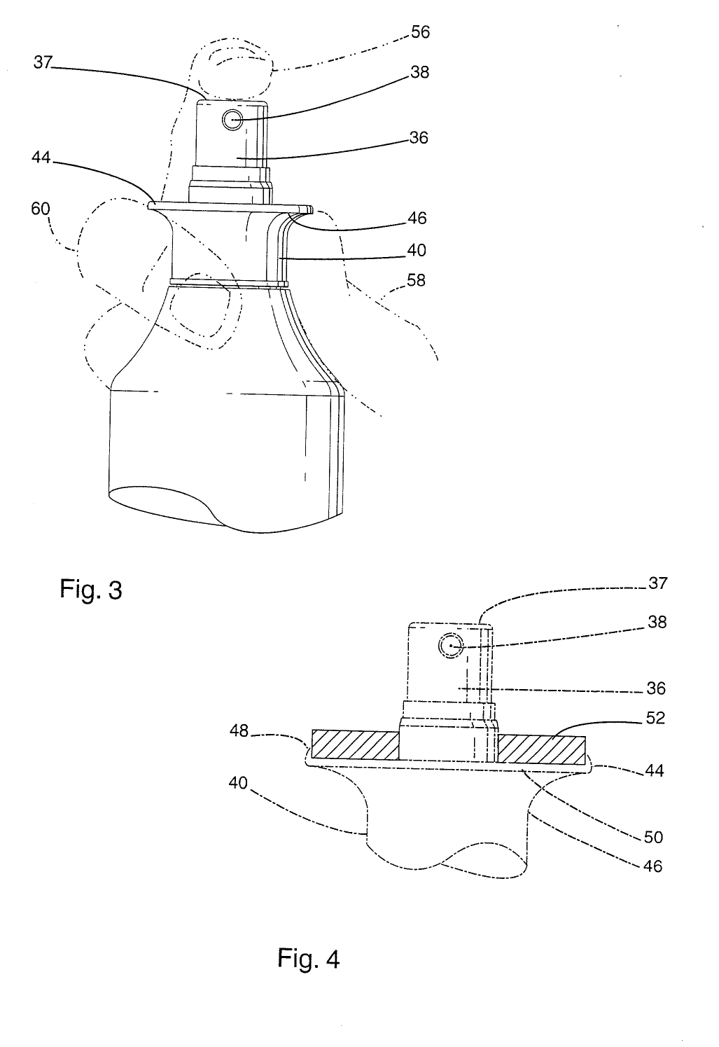

In use, and as shown in FIG. 3, index finger 56 of the user is placed on finger rest 37 of plunger 36. Middle finger 60 will abut the underside of flange 42 while thumb 58 may likewise be placed in a position against the underside of flange 42. With this arrangement, the fingers of the user are automatically placed in a correct position—the distances between the index finger and the middle finger are arranged at an ideal distance such that maximum force may be exerted by index finger 56 on plunger 36. This is to be differentiated from the arrangement shown in FIG. 2 wherein a maximum force can not be exerted on the plunger.

Flange 42 also serves to substantially prevent container 30 from becoming slippery due to moisture. The addition of absorbent foam 52 further aids in the above.

It will be understood that the above described embodiments are for purposes of illustration only and that changes and modifications may be made thereto without departing from the spirit and scope of the invention.

I claim:

1. A cap for use with a pump spray container, said cap comprising a body having an internal passageway to receive a spray mechanism, a side wall surrounding said passageway, a flange extending outwardly from an exterior surface of said side wall, said flange extending outwardly for a distance sufficient to act as an abutting member for a finger of a hand of a user.

2. The cap of claim 1 wherein said flange is an integral part of said side wall.

3. The cap of claim 1 further including an upwardly extending lip at the periphery of said outwardly extending flange.

4. The cap of claim 1 further including an absorbent material surrounding said side wall above said flange.

5. The cap of claim 4 wherein said absorbent material is a foam material.

6. The cap of claim 5 wherein said foam material is adhesively secured to said cap.

7. The cap of claim 5 wherein said foam material is resiliently secured to said cap.

8. The cap of claim 1 wherein said flange extends outwardly a distance of between 5 mm and 20 mm.

9. The cap of claim 1 wherein said cap is formed of a molded plastics material.

10. A method of positioning the index finger of a user on a spray container having a plunger, the method comprising the step of supplying a container having a cap, the cap comprising a body including a side wall, a flange extending outwardly from an exterior surface of said side wall, said flange extending outwardly for a distance sufficient to act as an abutting member for a finger of a hand of a user and said flange being spaced from said plunger by a distance sufficient to correctly position said index finger.
